(19) United States
(12) Patent Application Publication
(10) Pub. No.: US 2026/0116335 A1
(43) Pub. Date: Apr. 30, 2026

(54) FRONT STRUCTURE OF VEHICLE

(71) Applicant: TOYODA GOSEI CO., LTD., Kiyosu-shi (JP)

(72) Inventors: Hiroshi TAKAKURA, Kiyosu-shi (JP); Koishi SUZUKI, Kiyosu-shi (JP); Masashi OTOYO, Kiyosu-shi (JP); Joji AOYAMA, Kiyosu-shi (JP); Takaki ITATSU, Kiyosu-shi (JP)

(21) Appl. No.: 19/355,166

(22) Filed: Oct. 10, 2025

(30) Foreign Application Priority Data
Oct. 30, 2024 (JP) 2024-190959

(51) Int. Cl. B60R 21/38

(52) U.S. Cl. CPC B60R 21/38

(57) ABSTRACT

A front structure of a vehicle includes a main body formed from resin and a pop-up hood device. The pop-up hood device includes an actuator and a bracket used to fix the actuator to the main body. The main body includes two side walls spaced apart from each other and extending in a longitudinal direction, and a bottom wall connecting ends of the two side walls to each other from a first side in the longitudinal direction. The bottom wall includes a fastening hole to which the bracket is fastened by a fastener from a first side in the longitudinal direction, and a reinforcing rib projecting toward a second side in the longitudinal direction and defining, with at least one of the side walls, a surrounding portion surrounding the fastening hole.

### CROSS-REFERENCE TO RELATED APPLICATIONS

This application is based upon and claims the benefit of priority from Japanese Patent Application No. 2024-190959, filed on Oct. 30, 2024, the entire contents of which are incorporated herein by reference.

### BACKGROUND

### 1. Field

The following description relates to a front structure of a vehicle.

### 2. Description of Related Art

JP2015-151056A discloses a radiator support. A pop-up hood device of a vehicle is fixed to the radiator support. The pop-up hood raises the front end of the hood upon collision with an object, such as a pedestrian.

The radiator support includes two side support members, an upper support member, and a lower support member. The two side support members define the two ends of the radiator support in a lateral direction of the vehicle. The upper support member defines the upper end of the radiator support and extends between the two side support members in the lateral direction. The lower support member defines the lower end of the radiator support and extends between the two side support members in the lateral direction.

The pop-up hood device includes two actuators, which are activated upon collision with an object, and two brackets. Each actuator is fixed to one of the brackets and held in the vicinity of the corresponding side support member.

Such a radiator support is formed from steel to have sufficient rigidity and strength for enduring the load that acts on the radiator support when the actuator is activated.

It is desirable to reduce the weight of the radiator support without affecting the rigidity and strength for enduring the load described above. In the same manner, it is desirable to reduce the weight of the vehicle front structure that includes the main body portion, which forms the front part of the vehicle, and the pop-up hood device, which is fixed to the body portion.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a front structure of a vehicle includes a main body formed from resin and defining a section of a vehicle body at a front part of the vehicle and a pop-up hood device that includes an actuator configured to lift a front part of a hood of the vehicle when activated, and a bracket used to fix the actuator to the main body. The vehicle has a length in a longitudinal direction. The main body includes two side walls spaced apart from each other and extending in the longitudinal direction, and a bottom wall connecting ends of the two side walls to each other from a first side in the longitudinal direction. The bottom wall includes a fastening hole to which the bracket is fastened by a fastener from a first side in the longitudinal direction, and a reinforcing rib projecting toward a second side in the longitudinal direction and defining, with at least one of the side walls, a surrounding portion surrounding the fastening hole.

Other features and aspects will be apparent from the following detailed description, the drawings, and the claims.

### BRIEF DESCRIPTION OF THE DRAWINGS

FIG. 1 is a partial cross-sectional view of a front part of a vehicle where a front structure is installed in accordance with an embodiment.

FIG. 2 is a partial rear view of the front structure shown in FIG. 1.

FIG. 3 is a cross-sectional view taken along line 3-3 in FIG. 2.

FIG. 4 is an enlarged front view of the front structure focusing on where an actuator is attached.

FIG. 5 is a cross-sectional view taken along line 5-5 in FIG. 4.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

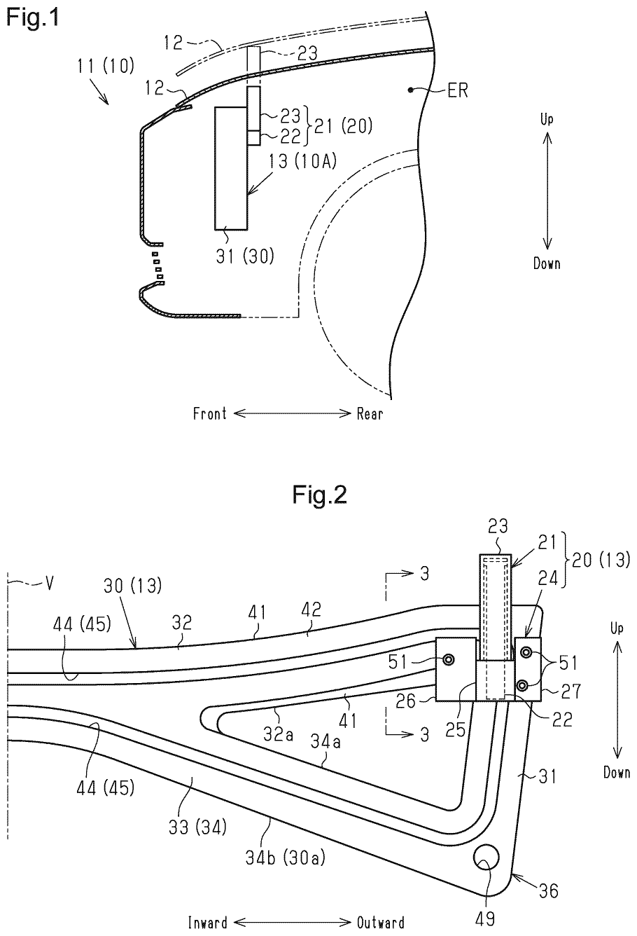

One embodiment of a front structure of a vehicle will now be described with reference to FIGS. 1 to 5. In the description hereafter, the longitudinal direction of a vehicle refers to the longitudinal direction and the “front side” and the “rear side” of the longitudinal direction will be referred to as the “front direction” and the “rear direction”. In the present embodiment, the “rear direction” is defined as “first side in the longitudinal direction” and the “front direction” is defined as “second side in the longitudinal direction”. Further, the width direction of the vehicle is referred to as the lateral direction. When a vehicle is positioned on a surface horizontally, the vertical direction of the vehicle is referred to as the vertical direction and an “upper side” and a “lower side” of the vertical direction will simply be referred to as the “upper side” and the “lower side”.

### Basic Structure of Front Part of Vehicle

As shown in FIG. 1, a front part 11 of a vehicle 10 includes a hood 12 and a front structure 13. The hood 12 covers an engine compartment ER from the upper side. The vehicle 10 has a width in a lateral direction and a length in a longitudinal direction. Two lateral ends of the hood 12 are each coupled by a hood hinge (not shown) to a vehicle body 10A. The two hood hinges support the hood 12 pivotally about an axis extending in the lateral direction of the vehicle 10. Further, as shown in FIG. 1, the hood 12 includes a hood lock (not shown) configured to lock the hood 12 when the hood 12 is located at a position shown in FIG. 1, where it closes the engine compartment ER (hereafter, referred to as a closed position).

The front structure 13 is arranged at the lower side of the front end of the hood 12. The front structure 13 includes a pop-up hood device 20 and a main body 30 to which the pop-up hood device 20 is attached. The pop-up hood device 20 and the main body 30 will now be described in detail.

### Pop-Up Hood Device

As shown in FIGS. 1 and 2, the pop-up hood device 20 includes actuators 21, which lift the hood 12, and brackets 24, which fix the corresponding actuators 21 to the main body 30. Further, FIG. 1 shows only one actuator 21 of the pop-up hood device 20 and does not show the brackets 24.

Each actuator 21, which is tubular throughout its entirety and elongated in the vertical direction, includes a piston 22 and a cylinder 23. A gas generator (not shown), which is electrically connected to an ECU (not shown) by a wire harness (not shown), is arranged inside the piston 22. A sensor, which detects that the vehicle 10 has collided with or is about to collide with a pedestrian or the like, is electrically connected to the ECU. Based on a signal input from the sensor, the ECU determines whether to activate the gas generator of the actuator 21. The cylinder 23 is tubular and accommodates the piston 22. When the gas generator is activated under the control of the ECU, the pressure of the gas generated inside the piston 22 forces the cylinder 23 upward relative to the piston 22. The actuator 21 is configured to lift the front end of the hood 12, with the cylinder 23 that rises in a state abut against the hood 12 from the closed position to a position indicated by the double-dashed line shown in FIG. 1.

The inward direction of the vehicle 10 is defined as the side located toward the middle of the vehicle 10 in the lateral direction, and the outward direction of the vehicle 10 is defined as the side located away from the middle of the vehicle 10 in the lateral direction.

Referring FIG. 2, each bracket 24 is formed from a sheet of metal. The bracket 24 includes a base 25, a first fixed portion 26, and a second fixed portion 27. The first fixed portion 26 and the second fixed portion 27 extend from the base 25 in the lateral direction. The base 25 covers a lower end of the piston 22 in the rear direction. The piston 22 is coupled to the inner surface of the base 25 through welding or the like. The first fixed portion 26 extends from the base 25 in the inward direction of the vehicle 10. The second fixed portion 27 extends from the base 25 in the outward direction of the vehicle 10.

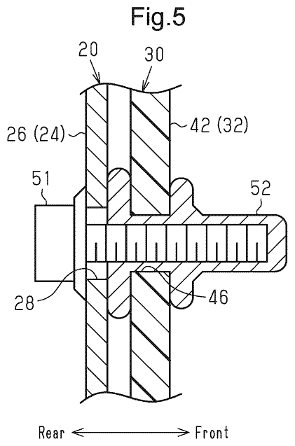

As shown in FIGS. 2 and 5, the first fixed portion 26 and the second fixed portion 27 include fastening holes 28 for insertion of bolts 51 acting as fasteners. In the present embodiment, the first fixed portion 26 includes one fastening hole 28, and the second fixed portion 27 includes two fastening holes 28.

### Main Body

As shown in FIG. 1, the main body 30 is a section of the vehicle body 10A at the front part 11 of the vehicle 10. The main body 30 is formed from resin, for example, through injection molding and is integrally molded. An example of the resin material forming the main body 30 is glass fiber reinforced polypropylene, which is formed by mixing glass fibers in polypropylene resin. In the present embodiment, the main body 30 is symmetrical relative to a virtual plane V (refer to FIG. 2). The virtual plane V is orthogonal to the lateral direction and extends through the middle of the main body 30 with respect to the lateral direction. The description hereafter will mainly focus on the right side of the main body 30 in the lateral direction.

Referring to FIG. 2, the main body 30 includes two side portions 31, an upper portion 32, and two stay portions 33. The two side portions 31 are spaced apart from each other in the lateral direction and extend in the vertical direction. The upper portion 32 extends in the lateral direction and connects the upper ends of the two side portions 31 to each other. Each stay portion 33 is inclined and extends inward from the lower end of the corresponding side portion 31 and is coupled to the upper portion 32. The hood lock device (not shown) is attached to, for example, the middle of the upper portion 32 with respect to the lateral direction. Each stay portion 33 is inclined upward in the inward direction. The stay portions 33 form an arch 34 in entirety. The arch 34 is curved so as to be higher toward the middle. An upper edge 34a of the arch 34 connects to a lower edge 32a of the upper portion 32 at the central part of the upper portion 32 in the lateral direction. A lower edge 34b of the arch 34 defines part of a peripheral edge 30a of the main body 30.

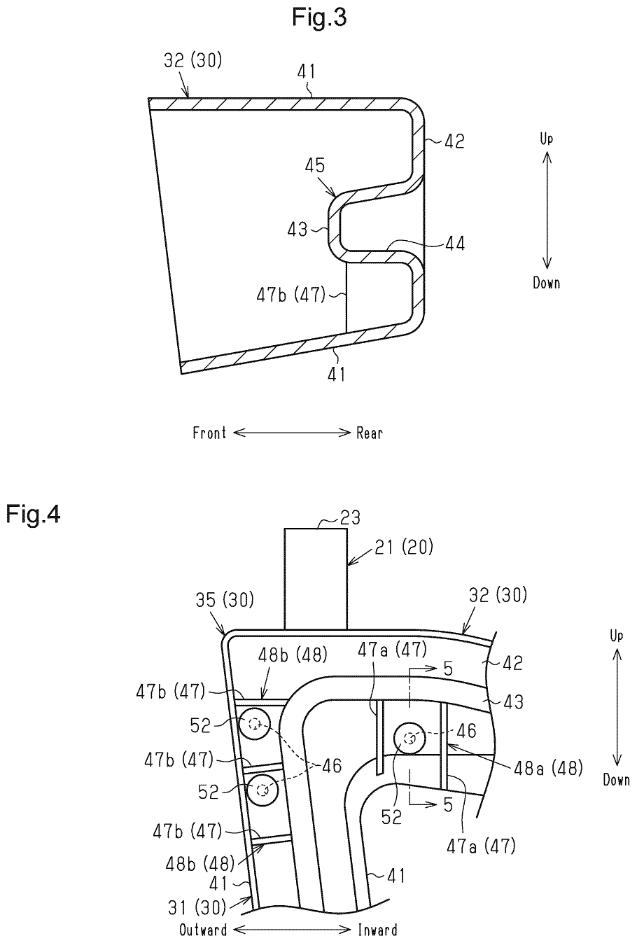

As shown in FIG. 3, the main body 30 includes two side walls 41 and a bottom wall 42. The side walls 41 extend in the longitudinal direction of the vehicle 10 and are spaced apart from each other. The bottom wall 42 joins the ends of the side walls 41 in the rear direction. A projection 43 projects in the front direction from the bottom wall 42. Further, a groove 44 that opens in the rear direction is arranged in the bottom wall 42 at the side opposite of the projection 43. A bead 45 is formed by the projection 43 and the groove 44.

As shown in FIG. 2, the bead 45 extends along the two side walls 41 throughout the entire main body 30. That is, the bead 45 is formed throughout the entire main body 30. The bead 45 extends continuously throughout the entire portions of the main body 30.

As shown in FIGS. 4 and 5, the actuators 21 are fixed to the main body 30 by the brackets 24 at locations where the side portions 31 are connected to the upper portion 32 (hereafter, referred to as connecting portions 35). In the present embodiment, one actuator 21 is fixed to each connecting portion 35. The bottom wall 42 at the connecting portion 35 includes fastening holes 46, into which the bolts 51 are inserted, and reinforcing ribs 47. In the present embodiment, there are three fastening holes 46, one for each of the three fastening holes 28 in the corresponding bracket 24. A blind nut 52, which acts as a fastener, is set in each fastening hole 46. The bracket 24 is placed on the connecting portion 35 in the rear direction. In this state, the bolts 51 inserted through the fastening holes 28, and the blind nuts 52 are fastened to the distal ends of the bolts 51. This fastens the actuator 21 to the main body 30 in the rear direction with the bracket 24 arranged in between.

As shown in FIGS. 3 and 4, the reinforcing ribs 47 project from the bottom wall 42 in the front direction. The reinforcing ribs 47 include vertical ribs 47a, which extend in the vertical direction and connect one of the side walls 41 to the projection 43, and horizontal ribs 47b, which extend in the lateral direction and connect one of the side walls 41 to the projection 43.

As shown in FIG. 4, the main body 30 includes surrounding portions 48 surrounding the fastening holes 46. The surrounding portions 48 include a first surrounding portion 48a and two second surrounding portions 48b. The first surrounding portion 48a surrounds the fastening hole 46 for fastening the first fixed portion 26. Each second surrounding portion 48b surrounds one of the two fastening holes 46 for fastening the second fixed portion 27. Each surrounding portion 48 forms a rectangular hollow section having four generally straight sides formed by two of the reinforcing ribs 47, the corresponding side wall 41, and the projection 43. The surrounding portions 48 surround the fastening holes 46. More specifically, the first surrounding portion 48a is defined by a portion of the side wall 41 extending in the lateral direction, a portion of the projection 43 extending in the lateral direction, and the two vertical ribs 47a connecting these two portions. Furthermore, the two second surrounding portions 48b are each defined by a portion of the side wall 41 extending in the vertical direction, a portion of the projection 43 extending in the vertical direction, and two of the horizontal ribs 47b connecting these two portions. In the present embodiment, the adjacent second surrounding portions 48b share the same horizontal rib 47b that is located between the two fastening holes 46 in the vertical direction.

As shown in FIG. 2, the two side portions 31 of the main body 30 each connect to the arch 34 at a connecting portion 36. A fastening hole 49 extends through the connecting portion 36. The fastening hole 49 is for a fastener that fastens the main body 30 to a front side member (not shown) of the vehicle body 10A.

### Operation of Present Embodiment

Each bracket 24 is fastened to the main body 30 in the rear direction by fastening the bolts 51 and the blind nuts 52, which act as the fasteners, to the fastening holes 46 of the main body 30. This fixes the actuators 21 of the pop-up hood device 20 to the connecting portions 35 of the main body 30.

Further, in the front structure 13 of the present embodiment, the main body 30 is formed integrally from a resin material. This decreases the weight of the main body 30, which in turn, decreases the weight of the front structure 13. Thus, the front structure 13 is lighter than when the main body 30 is formed from steel.

When the main body 30 is formed from a resin material, the load that acts on the main body 30 through the fastening holes 46 during activation of the actuator 21 may deform the main body 30. In such a case, the actuator 21 may not be able to lift the hood 12 sufficiently. In this regard, in the front structure 13 of the present embodiment, the first surrounding portion 48a and the second surrounding portions 48b, each surrounding one of the fastening holes 46, are formed by one of the side walls 41, two of the reinforcing ribs 47, and the projection 43. Thus, the side walls 41, the pairs of reinforcing ribs 47, and the projection 43 cooperate with one another to reinforce the connecting portion 35, which is where the fastening holes 46 extend through the main body 30. Accordingly, the main body 30 will withstand deformation even when load acts on the main body 30.

### Advantages of Present Embodiment

(1) The bottom wall 42 of the main body 30 includes the fastening holes 46 and the reinforcing ribs 47. The fixed portions 26 and 27 of the brackets 24 are fastened to the bottom wall 42 in the rear direction by the bolts 51 and the blind nuts 52, which act as the fasteners, in the fastening holes 46. The reinforcing ribs 47 are projected in the front direction and form the surrounding portions 48, which surround the fastening holes 46 with the side walls 41.

Such a structure operates in the above-described manner. This decreases the weight of the main body 30 without affecting the rigidity and strength for enduring the load from the actuator 21 of the pop-up hood device 20.

(2) The bottom wall 42 includes the projection 43 and the groove 44. Each surrounding portion 48 is formed by the side wall 41, the two reinforcing ribs 47, and the projection 43.

In this structure, the bead 45 is formed on the bottom wall 42 by the projection 43 and the groove 44. The bead 45 reinforces the bottom wall 42, which in turn, reinforces the main body 30.

Further, in the above structure, the side wall 41, the two reinforcing ribs 47, and the bead 45 cooperate with one another to reinforce the connecting portion 35, which is where the fastening holes 46 extend through the main body 30. Thus, even when load acts on the main body 30, deformation of the main body 30 will be more limited than when the surrounding portions 48 are formed by only the side walls 41 and the reinforcing ribs 47.

This increases the rigidity and the strength of the main body 30.

(3) The main body 30 is integrally molded. The main body 30 is formed from a fiber-reinforced plastic.

In this structure, the molded article surface includes a skin layer that is cooled and solidified before a central portion (core layer) of the molten resin in a cavity. In the skin layer, fibers are apt to being oriented in the flow direction of the molten resin. The strength of a fiber reinforced plastic is increased in the direction in which fibers are oriented. Thus, the skin layer increases the strength of the main body 30.

Further, in the above structure, the projection 43 increases the surface area of the main body 30. This increases the area of the skin layer. Thus, the rigidity and the strength of the main body 30 are further increased.

(4) The first surrounding portion 48a includes parts extending in the lateral direction. Such parts are formed by the side wall 41 and the projection 43. Further, each second surrounding portion 48b includes parts extending in the lateral direction. Such parts are formed by the two horizontal ribs 47b.

When the actuator 21 is activated, load acts toward the lower side of the main body 30 through the fastening holes 46 in the vertical direction. In this regard, with the above structure, parts of the first surrounding portion 48a formed by the side wall 41 and the projection 43 extend in the lateral direction, which is perpendicular to the vertical direction. Thus, load is distributed in a preferable manner by the side wall 41 and the projection 43. Further, parts of each second surrounding portion 48b formed by the two horizontal ribs 47b extend in the lateral direction, which is perpendicular to the vertical direction. Thus, load is distributed in a preferable manner by the two horizontal ribs 47b. Accordingly, even when load acts on the main body 30, deformation of the main body 30 will be further limited. This further increases the rigidity and the strength of the main body 30.

### Modifications

The above embodiments may be modified as described below. The above embodiments and the following modifications may be combined as long as the combined modifications remain technically consistent with each other.

The number of fastening holes 46 in each connecting portion 35 of the main body 30 in the present embodiment is not limited to three, and may be four or more. In this case, the number of the fastening holes 28 in each first fixed portion 26 and second fixed portion 27 of the bracket 24 may also be varied in correspondence with the number of the fastening holes 46. In accordance with the number of fastening holes 46, the surrounding portions 48 that surround the fastening holes 46 may be added.

Each second surrounding portion 48b does not have to be shaped as a rectangular hollow section as exemplified in the present embodiment. In this case, the horizontal ribs 47b do not have to extend straight in the lateral direction. For example, the horizontal ribs 47b may be curved relative to the lateral direction.

The vertical ribs 47a or the horizontal ribs 47b may be omitted so as to omit the first surrounding portion 48a or the second surrounding portions 48b.

Each surrounding portion 48 does not need to surround the corresponding fastening hole 46 entirely in the circumferential direction of the fastening hole 46 as exemplified in the present embodiment. For example, one of the two reinforcing ribs 47 may be omitted from the surrounding portion 48 so as to surround the fastening hole 46 partially in the circumferential direction. In this case, the surrounding portion 48 includes parts that are adjacent to the fastening hole 46 in three of four directions, namely, the upper direction, the lower direction, the inner direction, and the outer direction.

The resin material forming the main body 30 is not limited to polypropylene resin including glass fibers as exemplified in the present embodiment. The main body 30 may be formed by only a thermoplastic resin such as polypropylene resin or the like.

The bead 45 does not need to extend continuously around the entire main body 30. For example, multiple beads 45 may be arranged spaced apart from one another around the entire main body 30. Further, parts of the bead 45 that do not form the surrounding portions 48 may be omitted from the main body 30.

The groove 44 may be omitted from the bottom wall 42. In other words, the surface of the bottom wall 42 opposite the projection 43 in the longitudinal direction may be flat.

The main body 30 does not need to include the bead 45. In other words, the projection 43 and the groove 44 may be omitted from the bottom wall 42. In this case, reinforcing ribs differing from the reinforcing ribs 47 that form the surrounding portions 48 may be arranged on each component of the main body 30. Further, in this case, the surrounding portions 48 do not have to be formed by the side wall 41, the reinforcing ribs 47, and the projection 43. The projection 43 may be replaced by additional reinforcing ribs 47. In other words, the surrounding portions 48 may be formed by only the side walls 41 and the reinforcing ribs 47.

In the front structure 13, the actuators 21 do not have to be fixed to the rear side of the main body 30. The actuator 21 may be fixed to the front side of the main body 30. Further, the bottom wall 42 does not have to connect the ends of the two side walls 41 at the rear side. The bottom wall 42 may connect the ends of the two side walls 41 at the front side. In this modification, the front side refers to a first side in the longitudinal direction and the rear side refers to a second side in the longitudinal direction.

In the front structure 13, one pop-up hood device 20 is attached to each of the lateral sides of the main body 30. This, however, is not a limitation. For example, only one pop-up hood device 20 may be attached to the laterally central part of the upper portion 32.

The front structure 13 of the vehicle 10 in accordance with the present disclosure may be embodied in a radiator support that supports a radiator.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A front structure of a vehicle, the front structure comprising:
a main body formed from resin and defining a section of a vehicle body at a front part of the vehicle; and
a pop-up hood device including an actuator configured to lift a front part of a hood of the vehicle when activated, and a bracket used to fix the actuator to the main body, wherein
the vehicle has a length in a longitudinal direction,
the main body includes two side walls spaced apart from each other and extending in the longitudinal direction, and a bottom wall connecting ends of the two side walls to each other from a first side in the longitudinal direction, and
the bottom wall includes a fastening hole to which the bracket is fastened by a fastener from the first side in the longitudinal direction, and a reinforcing rib projecting toward a second side in the longitudinal direction and defining, with at least one of the side walls, a surrounding portion surrounding the fastening hole.

2. The front structure according to claim 1, wherein
the bottom wall includes a projection projecting towards the second side in the longitudinal direction and extending along the two side walls, and a groove arranged at an opposite side of the projection in the longitudinal direction and open toward the first side in the longitudinal direction, and
the surrounding portion is defined by the at least one of the side walls, the reinforcing rib, and the projection.

3. The front structure according to claim 1, wherein the main body is formed from a fiber-reinforced plastic.

4. The front structure according to claim 1, wherein
the vehicle has a width in a lateral direction,
the surrounding portion includes a part extending in the lateral direction, and
the part of the surrounding portion extending in the lateral direction includes the reinforcing rib or the at least one of the side walls.
